(19) United States
(12) Patent Application Publication
(10) Pub. No.: US 2024/0037820 A1
(43) Pub. Date: Feb. 1, 2024

(54) Methods And Systems For Use In Mapping Tillage Based On Remote Data

(71) Applicant: CLIMATE LLC, Saint Louis, MO (US)

(72) Inventors: Angeles CASAS, San Francisco, CA (US); Yu LIU, Newark, CA (US); Pratik SHRIVASTAVA, Saint Louis, MO (US); Jun XIONG, Moraga, CA (US)

(21) Appl. No.: 18/226,215

(22) Filed: Jul. 25, 2023

Related U.S. Application Data
(60) Provisional application No. 63/393,785, filed on Jul. 29, 2022.

(51) Int. Cl. G06T 11/20; G06V 20/10; G06T 11/00

(52) U.S. Cl. CPC G06T 11/206; G06V 20/188; G06V 20/194; G06T 11/001

(57) ABSTRACT

Systems and methods are provided for use in mapping tillage in fields based in remote data. One example computer-implemented method includes accessing, by a computing device, an image of one or more fields, where the image includes multiple pixels and where each of the pixels includes a value for each of multiple bands. The method also includes deriving, by the computing device, at least one index value the image and generating a map of tillage for the one or more fields using a trained model and the at least one index value for each of the pixels of the image. The method further includes storing the map of tillage for the one or more fields in a memory and causing display of the map of tillage for the one or more fields at an output device.

### CROSS-REFERENCE TO RELATED APPLICATION

This application claims the benefit of, and priority to, U.S. Provisional Application No. 63/393,785, filed Jul. 29, 2022. The entire disclosure of the above application is incorporated herein by reference.

### FIELD

The present disclosure generally relates to methods and systems for use in mapping tillage (e.g., conservation tillage, etc.) in fields, based on remote image data.

### BACKGROUND

This section provides background information related to the present disclosure which is not necessarily prior art.

Images of fields are known to be captured in various manners, including, for example, by satellites, unmanned and manned aerial vehicles, etc. The images captured in this manner may be analyzed to derive data related to the fields, including, for example, greenness or normalized difference vegetative index (NDVI) data for the fields, which may form a basis for management decisions related to the fields.

### SUMMARY

This section provides a general summary of the disclosure, and is not a comprehensive disclosure of its full scope or all of its features.

Example embodiments of the present disclosure generally relate to computer-implemented methods for use in processing image data associated with fields. In one example embodiment, such a method generally includes accessing, by a computing device, an image of one or more fields, the image including multiple pixels, each of the pixels including a value for each of multiple bands; deriving, by the computing device, at least one index value for each of the pixels of the image; and generating a map of tillage for the one or more fields using a trained model and the at least one index value for each of the pixels of the image. In addition, the method may also include storing, by the computing device, the map of tillage for the one or more fields in a memory. Further, the method may also include causing display of (or displaying) the map of tillage for the one or more fields at an output device.

Example embodiments of the present disclosure also generally relate to systems for use in processing image data associated with fields. In one example embodiment, such a system generally includes a computing device configured to perform one or more operations of the methods described herein. Example embodiments of the present disclosure also generally relate to computer-readable storage media including executable instructions for processing image data associated with fields. In one example embodiment, a computer-readable storage medium includes executable instructions, which when executed by at least one processor, cause the at least one processor to perform one or more operations described herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for mapping tillage in multiple fields, based on image data associated with the multiple fields;

FIG. 2 is a block diagram of an example computing device that may be used in the system of FIG. 1;

FIG. 3 illustrates a flow diagram of an example method, suitable for use with the system of FIG. 1, for mapping tillage to specific segments of fields, based on image data for the fields;

FIG. 4 illustrates differences between different instances (or intensities) of tillage, including that resulting from (or produced by) conventional tilling, conservative tilling and no tilling; and

FIG. 5 illustrates an example map of tillage (or tillage map) for multiple fields, which includes different segments associated with (and/or indicative of) different instances (or intensities) of tillage.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In grower operations related to fields, from time to time, growers may determine to till their fields, in whole or in part, in one or more manners, to increase soil water retention, to control soil erosion, etc., and which may mitigate or reduce nutrient losses due to runoff. By reducing tillage intensity, though, crop residue in the fields may be increased, which, in turn, may retain nutrients in the soil and promote sustainable cropping operations in the fields. Tillage data is limited, however, by the reporting of tillage by the growers, and tillage intensity with accurate location data, to properly associate the tillage, and tillage intensity, to the specific field, and also potentially, to different segments within the fields, which are exposed to different intensities of tillage. That is, the accuracy of tillage data gained from the growers is insufficient to justify use of the tillage data in other operations (e.g., prescriptions, prediction, management practices, etc.).

Uniquely, the systems and methods herein leverage remote data for various fields, and in particular, image data associated with the various fields, to map tillage in the various fields. In this manner, a more accurate representation of tillage data may be provided.

The tillage is characterized by location, and additionally, pursuant to the systems and methods herein, the intensity of the tillage in the fields, potentially by segment (or part) within the fields. In particular, a computing device accesses images of the fields (broadly, image data for the fields) and applies a trained model to the images to identify intensity of tillage in the fields and, more particularly, in specific segments of the fields. In this manner, tillage of the fields and an intensity of the tillage is identified to specific segments of the fields, or to the whole fields, to accurately document the tillage data for the fields and inform the growers, and others associated with the fields, to the performed tillage. The tillage data may then be leveraged to inform crop management (e.g., weed control, pest control, nutrient control, etc.) and to predict yield performance of crops in the fields.

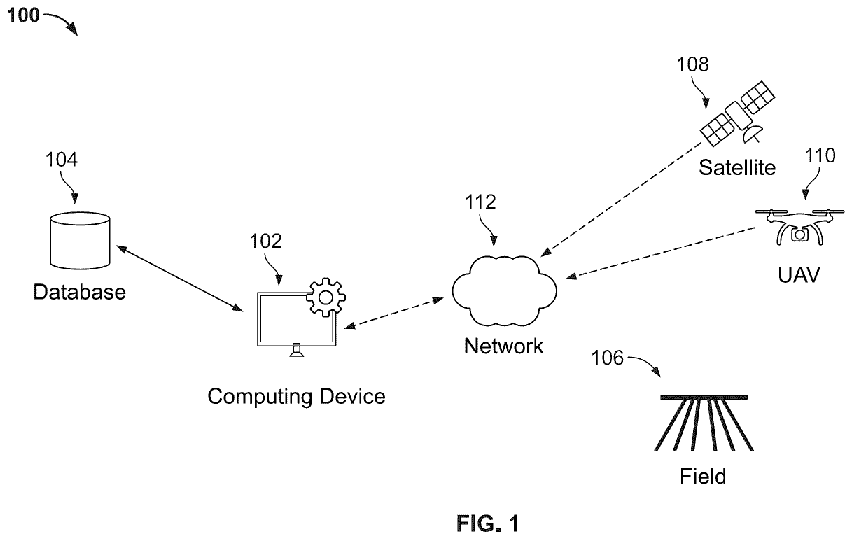

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, types of images available, manner in which the images are obtained (e.g., via satellites, aerial vehicles, etc.), types of fields, size and/or umber of fields, crops present in the fields, crop or management practices (e.g., tillage, etc.) in the fields, etc.

As shown, the system 100 generally includes a computing device 102, and a database 104 coupled to (and in communication with) the computing device 102, as indicated by the arrowed line. The computing device 102 and database 104 are illustrated as separate in the embodiment of FIG. 1, but it should be appreciated that the database 104 may be included, in whole or in part, in the computing device 102 in other system embodiments. The computing device 102 is also coupled to (and in communication with) network 112. The network 112 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof.

That said, in general, the computing device 102 is configured to initially access a data set (or multiple data sets) including images of one or more fields from the database 104 (e.g., where the images are collected as generally described herein, for example, from satellites, from other aerial vehicles, etc.) along with tillage data for the field(s). The computing device 102 is then configured to train a model using the accessed data for identifying intensity of tillage in the field(s). And, once the model is trained, the computing device is configured to access a data set including images of a particular field (or fields) and use the trained model to identify intensity of tillage in the particular field(s). The computing device 102 is configured to then map the tillage intensity for segment(s) of the field(s), where each segment is thereby identified to a given tillage intensity.

In connection with the above, the system 100 includes various fields, which are represented herein by field 106. The fields, in general, are provided for planting, growing and harvesting crops, etc., in connection with farming or growing operations, for example. While only one field 106 is shown in FIG. 1, it should be appreciated that the field 106 may be representative of dozens, hundreds or thousands of fields associated with one or more growers. The fields may each cover less than an acre, an acre, or multiple or several acres (e.g., at least about two acres, about ten or more acres, about fifty or more acres, about one hundred or more acres, about two hundred or more acres, etc.). It should also be understood that the various fields may be understood to include (or to more generally refer to) growing spaces for crops, and which are exposed for satellite and aerial imaging regardless of size, etc. Further, it should be appreciated that the fields may be viewed as including one or multiple segments, which are differential from one another in images of the fields, whereby the segment(s) may be one or more meters by one or more meters, or larger or smaller, etc.

In this example embodiment, each of the fields is subject to planting, growing and harvesting of crops in various different seasons. In connection therewith, the fields may be exposed to different machinery, management practices (e.g., treatments, harvesting practices, etc.), etc. One management practice, in particular, includes tilling, or tillage, whereby the field 106, for example, is subject to mechanical agitation to clear or otherwise prepare the field for growing crops. The tillage may be characterized by different intensities, by which different amounts or percentages of residue is left in the field 106. Table 1 illustrates a number of different types of example intensities of tillage that may be applied in or implemented in (or for) the field 106, whereby a corresponding residue remains. The different intensities are associated with both labels (e.g., Conventional Reduced, etc.) and groups (CT, MT, NT).

TABLE 1

| Labels (Tillage) | Residue % | Groups |
|---|---|---|
| Conventional | <15-30% | Conventional (CT) |
| Reduced | 15-30% | Conservation or |
| Conservation: Ridge-Till | 30-50% | Minimum Tillage (MT) |
| Minimum | >30% | |
| Conservation: Strip-Till | ~50% | |
| Plow | 70-90% | |
| Conservation: No-Till | 100% | No-Till (NT) |

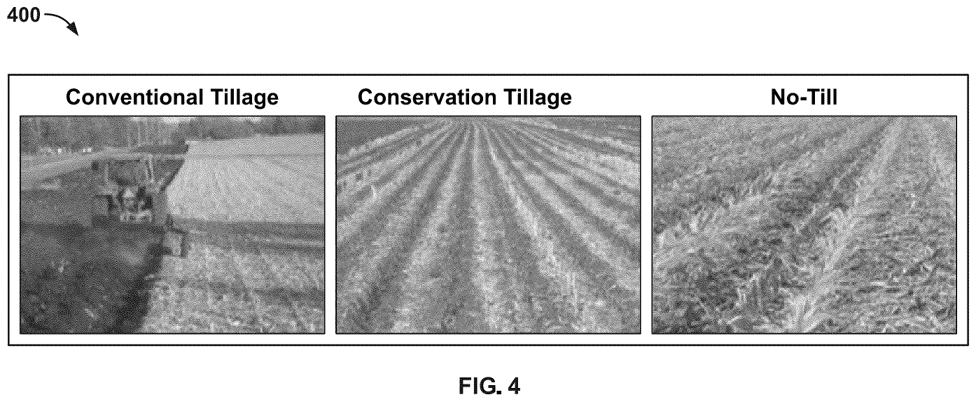

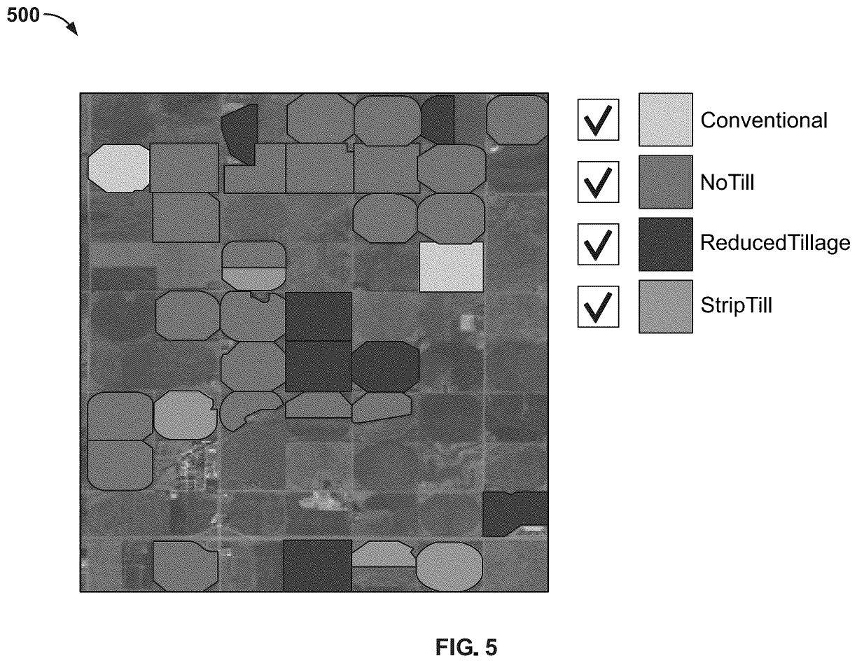

As shown, the residue from the different intensities of tillage ranges from less than 15% for conventional tillage to 100% for no tillage, with different residues included therebetween for other intensities of tillage. Examples of the different intensities of tillage are shown, for example, in FIG. 4, which are then grouped, for example, into a conventional tillage (CT) category, a conservative tillage (or minimum tillage (MT)) category, and a no tillage (NT) category. It should be appreciated that tillage intensity may include more or fewer divisions than illustrated in Table 1 (or than illustrated in FIGS. 4 and 5), for example, based on one or more percentages of residue, and may also be classified, grouped or labeled otherwise in various other embodiments (e.g., into other than three groups, etc.). For instance, in some embodiments strip-till may be classified into its own group (e.g., as shown in FIG. 5, etc.).

Further, the system 100 includes multiple image capture devices, including, in this example embodiment, a satellite 108 and an unmanned aerial vehicle (UAV) 110. In connection therewith, an image captured by (or from) the satellite 108 may be referred to as a sat_image. And, an image captured by (or from) the UAV 110 may be referred to as a UAV_image. While only one satellite 108 and one UAV 110 are illustrated in FIG. 1, for purposes of simplicity, it should be appreciated that system 100 may include multiple satellites and/or multiple UAVs (or may include access to such satellite(s) and/or such UAV(s)). What's more, the same and/or alternate image capture devices (e.g., including a manned aerial vehicle (MAV), etc.) may be included in other system embodiments.

With respect to FIG. 1, in particular, the satellite 108 is disposed in orbit about the Earth (which includes the field 106) and is configured to capture images of the field 106. As indicated above, the satellite 108 may be part of a collection of satellites (including multiple companion satellites) that orbit the Earth and captures images of different fields, including the field 106. Examples of satellite images may include, for instance, Copernicus Sentinel-2 images (e.g., Level-2A, etc.), Sentinel S1 Synthetic Aperture Radar (SAR) imagery (e.g., in VV mode, VH mode, etc.), Landsat images, MODIS (Moderate Resolution Imaging Spectroradiometer) images, etc. In this example embodiment, the satellites (including the satellite 108) form a network of satellites, which, individually and together, may be configured to capture images, at an interval of once per N days, where N may include one day, two days, five days, weekly, ten days, 15 days, 30 days, or another number of days, or on specific dates (e.g., relative to planting, harvest, etc.), etc. In addition, the satellite 108 is configured to capture images having a spatial resolution of about one meter or more by one meter or more per pixel, or other resolution, etc.

The UAV 110 may be configured to capture images at the same, similar or different intervals to that described for the satellite 108 (e.g., once per N days, where N may include one day, two days, five days, weekly, ten days, 15 days, 30 days, or another number of days, etc.) or on (or for) specific dates (e.g., relative to planting, harvest, etc.). The UAV 110, though, generally captures image at a higher spatial resolution than the satellite 108. For example, the UAV 110 may capture images having a spatial resolution of about five inches or less by about five inches or less per pixel, or other resolutions.

It should be appreciated that the satellite images and the UAV images may be upscaled or downscaled, from a spatial resolution perspective, as appropriate for use as described herein. It should also be appreciated that the satellite 108 and the UAV 110 may be configured to transmit, directly or indirectly, the captured satellite images and the captured UAV images, respectively, to the computing device 102 and/or the database 104 (e.g., via the network 112, etc.), whereby the images are stored in the database 104. The images may be organized, in the database 104, by location, date/time, and/or field, etc., as is suitable for use as described herein.

In this example embodiment, for certain ones of the fields (e.g., including the field 106, etc.), the database 104 further includes tillage data for the fields, if any. The tillage data is designated in a manner which is linked to one or more images of the fields, or vice versa. The tillage data indicates, for a specific field, or for one or more segments of the field, a tillage intensity (as defined, for example, in Table 1), as performed on the field (e.g., by a cultivating farm machine, etc.) (e.g., a ground truth), a specific temporal indicator for the tilling of the field (e.g., a time and date, etc.), a geospatial boundary of the tillage (e.g., as defined by the field, by a segment in the field (e.g., a strip, etc.), or otherwise, etc.), etc. The tillage data may further include or may be associated with other data related to the field, including, for example, a planting date for the crop in the field, a soil condition, a type of the crop, etc. The tillage data may be available for various types of fields, including, for example, trial fields in which the conditions of the fields is monitored closely in connection with the trial and other fields.

The images (regardless of whether they are satellite images or UAV images) include data indicative of various bands of wavelengths (e.g., within the electromagnetic spectrum, etc.). For example, the images, and more specifically each pixel of the images, may include data (or wavelength band data or band data) related to the color red (R) (e.g., having wavelengths ranging between about 635 nm and about 700 nm, etc.), the color blue (B) (e.g., having wavelengths ranging between about 490 nm and about 550 nm, etc.), the color green (G) (e.g., having wavelengths ranging between about 520 nm and about 560 nm, etc.), and near infrared (NIR) (e.g., having wavelengths ranging between about 800 nm and about 2500 nm, etc.), etc.

In this example embodiment, the computing device 102 is configured to access (e.g., from the database 104, etc.) certain ones of the images for various fields (associated with the known and/or available tillage data for the fields) and to train a model to classify the fields, or segments thereof, by tillage.

In connection therewith, the computing device 102 is configured to access images associated with an interval before a planting date of the fields, for example, and an interval after the planting of the fields, for instance, to provide a balanced signal-to-noise ratio to (or for) the machine learning approach described herein. The interval(s) may be the same or different, and may include about one month, about two months, about three months, about four months, about five months, about six months, or more or less, etc. In one specific example, to provide such a balanced signal-to-noise ratio, satellite images from about two months prior to planting dates for crops in the fields, and about four months after the planting dates of the crops are accessed.

In addition, after accessing the desired images, and as part of training the model, the computing device 102 is configured to compile a composite data set for the images, which includes (e.g., which aggregates, etc.) the images for the fields (e.g., aggregated by time interval (e.g., monthly composites, etc.), distribution-based, or pixel-based time series characteristics, etc.), tillage data for the fields, and any boundaries associated with the images and/or tillage data.

The computing device 102 is configured to then process the composite data set. In connection therewith, the computing device 102 may be configured to modify the band data for each of the accessed images. In particular, the computing device 102 may be configured to transform the data, as necessary, into a number of bands, which may include the above R, G, B, and NIR bands, and the add the bands as desired combinations thereof. In one example, the images, per pixel, are expressed as blue, green, red, short-wave infrared 1 or swirl, short-wave infrared 2 or swir2, NIR, NDVI (e.g., (NIR−Red)/(NIR+Red); etc.), NDTI(i.e., swir1−swir2)/(swir1+swir2)), STI (i.e., swir1/swir2), NDI5 (i.e., (NIR−swir1)/(NIR+swir1)), NDI7 (i.e., NIR−swir2)/(NIR+swir2)), and CRC (swir1−Green)/(swir1+Green)), etc. The pixels are then expressed in optical bands and derived indices. The computing device 102 is next configured to append the processed data to the composite data set. That said, it should be appreciated that the image pixels may be expressed otherwise as optical bands or derived indices (e.g., through other combinations of band data, etc.) in other system embodiments. In addition to the above, or alternatively, for example, the multiple accessed images may be combined in one or more manners including, for example, for each field, median values may be computed at a pixel-level from the images (e.g., after QC masking has been done, etc.) for each calendar month during the given intervals. More generally, the images may be aggregated, based on one or more techniques, including by time interval (e.g., monthly composites, etc.), distribution-based, or pixel-based time series characteristics, etc.).

Additional image data may also include VV (backscatter after terrain correction), VH (backscatter after terrain correction), etc. As it relates to the VV and VH, the image data is subject to one or more of terrain correction, radiometric correction, and/or backscatter normalization to provide the data in a form to be input herein. It should be appreciated that such image data may be included in and/or provided as part of satellite images, and in particular, the Sentinel Si Synthetic Aperture Radar (SAR) imagery (e.g., in VV mode, VH mode, etc.),

In other example embodiments, the computing device 102 may be configured to (additionally or alternatively) process the images and/or band data associated with the composite data, for example, by (or using) cloud masking, quality control operations, and other techniques to promote accuracy of the images of the field 106.

Next in the system 100, the computing device 102 is configured to split the composite data set into a training subset and a validation subset. Pixels within each field of the image data may be highly correlated in one or more implementations, whereby the pixels should be retained in either training subsets or the validation subsets, to prevent, for example, data leakage and/or overfitting. The computing device 102 may employ gridding over plots/fields as a spatial stratification.

The computing device 102 is then configured to train the model, which may include, for example, a random forest model, an Extreme Gradient Boosting or XGBoost model, a Residual Neural Network or Resnet model (e.g., RESNET 1D, etc.), or other suitable model, etc. The model is trained to produce two outputs based on the inputs, where the outputs include tillage class (e.g., CT, MT, NT, etc.) and tillage Y/N. It should be appreciated that the tillage classes may include a no till class, whereby the model is trained to output a tillage class (but not a sperate tillage Y/N output). And, in turn, the computing device 102 may be configured to validate the trained model, based on the validation subset of the composite data set, which, again, includes the same type of input data and tillage intensity data. The model is validated when a sufficient performance of the model is achieved.

After training, the computing device 102 is configured to access an image (or images) of a particular field, such as, for example, the field 106. In doing so, the computing device 102 is configured to use, for example, a time-series classification to retrieve image(s) that meet desired criteria, carry out preprocessing (e.g., cloud masking, etc.), and then to perform a monthly-median-composite over clear pixels.

The computing device is then configured to process the data for the image in the same manner as above (e.g., derive one or more indices, etc.), and then to employ the trained model to identify tillage intensity in the field, as a whole or by segments included therein. Then, finally in the system 100, in this example, the computing device 102 is configured to generate a map of the field, which includes the tillage intensity of the field and/or segments thereof. The different tillage intensities may be visually distinct, by color, pattern, identifier, etc., and sufficiently transparent to be overlaid on an image or representation of the field. The computing device 102 is configured to then display the map to one or more users (e.g., via the FIELDVIEW service from Climate LLC, Saint Louis, Missouri; etc.). As described, the map may then be used and/or leveraged to inform one or more crop management decisions with regard to the field 106 (e.g., direction operation of a farm implement to apply desired treatments to the fields such as pesticides, a herbicides, and/or a fertilizers; etc.).

For example, from the above, based on the identified tillage intensity in the field 106 (e.g., and the mapping thereof, etc.), the computing device 102 may be configured to generate one or more instructions (e.g., scripts, plans, etc.) for treating the field 106 (e.g., the crop in the field 106, etc.). The computing device 102 may then transmit the instructions to an agricultural machine, etc., whereby upon receipt, the agricultural machine, etc. automatically operate(s), in response to the instructions, to treat the crop in the field 106 (e.g., the instructions are used to control an operating parameter of the agricultural machine, etc.). Such treatment, processing, etc. of the crop, as defined by the instructions, may include directing the agricultural machine (e.g., causing operation of the machine, etc.) to apply one or more fertilizers, herbicides, pesticides, etc. (e.g., as part of a treatment plan, etc.); etc. In this way, the agricultural machine, etc. operates in an automated manner, in response to the identified tillage intensity in the field 106, to perform one or more subsequent agricultural tasks.

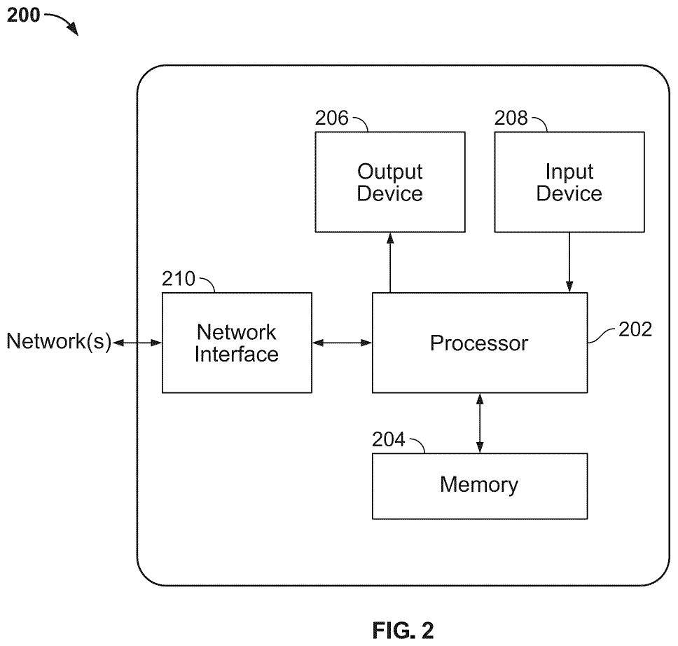

FIG. 2 illustrates an example computing device 200 that may be used in the system 100 of FIG. 1. The computing device 200 may include, for example, one or more servers, workstations, personal computers, laptops, tablets, smartphones, virtual or cloud-based devices, etc. In addition, the computing device 200 may include a single computing device, or it may include multiple computing devices located in close proximity or distributed over a geographic region, so long as the computing devices are specifically configured to operate as described herein. In the example embodiment of FIG. 1, the computing device 102 and the database 104 (and the satellite 108 and the UAV 110) may each include and/or be implemented in one or more computing devices consistent with (or at least partially consistent with) computing device 200. However, the system 100 should not be considered to be limited to the computing device 200, as described below, as different computing devices and/or arrangements of computing devices may be used. In addition, different components and/or arrangements of components may be used in other computing devices.

As shown in FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. In connection therewith, the memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 204 is configured to store data including and/or relating to, without limitation, images, models, tillage, fields, plots, trials, and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein (e.g., one or more of the operations of method 300, etc.) in connection with the various different parts of the system 100, such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special-purpose computing device. It should be appreciated that the memory 204 may include a variety of different memories, each implemented in connection with one or more of the functions or processes described herein.

In the example embodiment, the computing device 200 also includes an output device 206 that is coupled to (and is in communication with) the processor 202. The output device 206 may output information (e.g., crop characteristics, metrics, defined resolution images, etc.), visually or otherwise, to a user of the computing device 200, such as a researcher, a grower, etc. It should be further appreciated that various interfaces (e.g., as defined by the FIELDVIEW service, commercially available from Climate LLC, Saint Louis, Missouri; etc.) may be displayed at computing device 200, and in particular at output device 206, to display certain information to the user. The output device 206 may include, without limitation, a liquid crystal display (LCD), a light-emitting diode (LED) display, an organic LED (OLED) display, an “electronic ink” display, speakers, etc. In some embodiments, output device 206 may include multiple devices. Additionally, or alternatively, the output device 206 may include printing capability, enabling the computing device 200 to print text, images, and the like on paper and/or other similar media.

In addition, the computing device 200 includes an input device 208 that receives inputs from the user (i.e., user inputs) such as, for example, selections of fields, desired characteristics, etc. The input device 208 may include a single input device or multiple input devices. The input device 208 is coupled to (and is in communication with) the processor 202 and may include, for example, one or more of a keyboard, a pointing device, a touch sensitive panel, or other suitable user input devices. It should be appreciated that in at least one embodiment an input device 208 may be integrated and/or included with an output device 206 (e.g., a touchscreen display, etc.).

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network capable of supporting wired and/or wireless communication among two or more of the parts illustrated in FIG. 1, etc.) (e.g., network 112, etc.), including with other computing devices used as described herein.

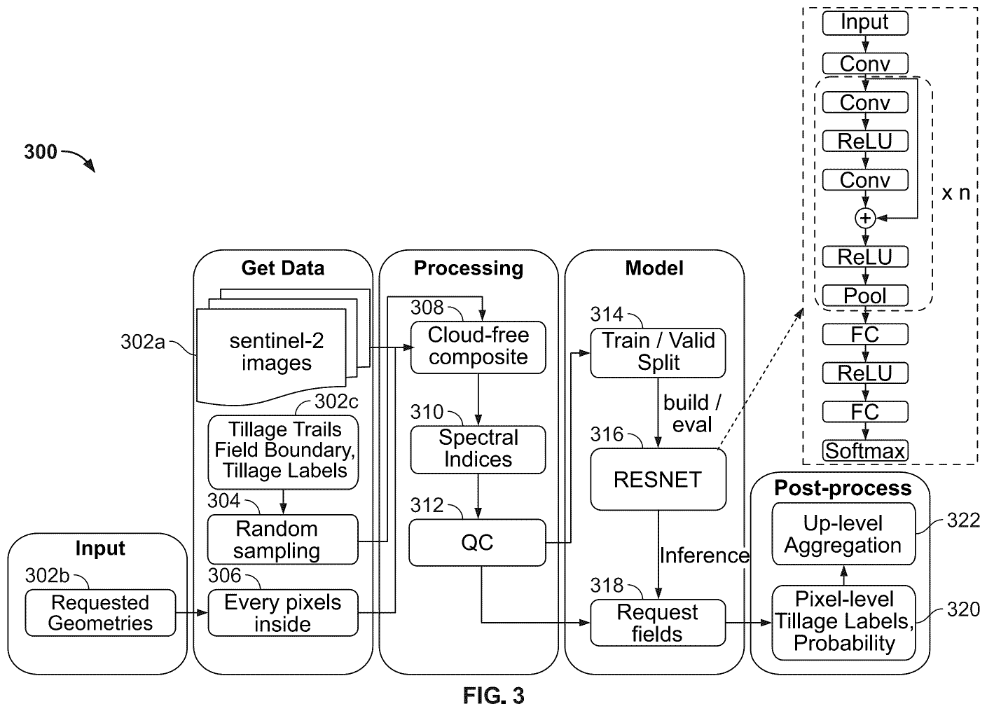

FIG. 3 illustrates an example method 300 for mapping tillage in fields, based in image data associated with the fields. The method 300 is described herein in connection with the system 100, and may be implemented, in whole or in part, in the computing device 102 of the system 100, and also the computing device 200. However, it should be appreciated that the method 300, or other methods described herein, are not limited to the system 100 or the computing device 200. And, conversely, the systems, data structures, and the computing devices described herein are not limited to the example method 300.

At the outset in the method 300, the computing device 102 accesses (or requests) the desired input data. For instance, at 302a, the computing device 102 accesses images for a relevant region, such as, for example, regions associated with desired fields (e.g., that include different trials, etc.) (e.g., through Descartes Lab, etc.). As explained above, the images may include satellite images (e.g., Sentinel-2 images (e.g., Level-2A, etc.), Sentinel S1 Synthetic Aperture Radar (SAR) imagery (e.g., in VV mode, VH mode, etc.), Lansat images, MODIS images, etc.) or UAV images (or other images), where each pixel includes particular band data, such as, for example, values for R, G, B, and NIR. At 302b, the computing device 102 accesses boundary data for specific fields (e.g., including field 106, etc.), as a whole or by segments included in the fields. And, at 302c, the computing device 102 accesses tillage data for the fields (e.g., from the different trials in the fields, etc.), which includes tillage information (or labels) along with the corresponding boundary data (e.g., inclusion of tillage, location of tillage and intensity, etc.).

At 304, the computing device 102 randomly samples the accessed tillage data (as accessed at 302c). This may help account for data (e.g., images, other data, etc.) taken from different sizes of fields, where there may be a large amount of data for larger fields (e.g., a larger number of images, etc.) but only a small amount of data for smaller fields (e.g., only one or a few images, etc.). In other words, randomly sampling the accessed data may aid in avoiding oversampling in larger fields and, thus, potential overfitting.

At 306, the computing device 102 evaluates, determines, etc. the pixels (e.g., data associated therewith, etc.) within the images included in the accessed boundary data (as accessed at 302b). For instance, the computing device 102 may determine, for each pixel of each image, particular band data related to R, G. B, and NIR (e.g., the values for R, G. B, and NIR; etc.). To this point, the area of the accessed boundary data may be limited to sizes bigger than a threshold, for example, of 0.5 acres. As such, any geometry smaller than the threshold will be dropped to avoid uncertainty of extracting satellite pixels in such geometries. In doings so, the filtered geometry(ies) may be rasterized by the computing device 102 into a 10 m×10 m pixel array. And then, the computing device 102 may perform a sub-sampling, which randomly selects 20 pixels from the array and drops the rest of the pixels, to avoid repeatedly sampling the same pixel.

The computing device 102 then generates, at 308, a composite data set from the images, the boundary data and the tillage data, which links each of the images to the tillage data and limits the data to the specific geolocations and/or boundaries of the desired fields. In one example, the tillage data includes intensity data, which is scaled or otherwise transformed, as shown in Table 1, from the labels to the classes of tillage intensity.

Next, at 310, the computing device 102 derives one or more spectral indices from the composite data set. In this example, the computing device 102 derives NDVI from Red and NIR data (as described above). The computing device 102 may also derive indices relating to one or more of swir1, swir2, sti, ndi5, ndi7, and crc, etc. After the one or more indices are derived, the computing device 102 performs, at 312, one or more quality control operations. To this point, the method 300 is a time-series classification approach, whereby the data quality of the remote sensing image(s) and its consistency over time may impact model performance. For instance, the satellite images may be affected and distorted by cloud, shadow, saturated and snow pixels. As such, as part of the quality control operations, the computing device 102 may use a pixel-based classification map and remove undesirable pixels from the images (e.g., cloud, shadow, saturated and snow pixels; etc.).

At 314, the computing device 102 splits the composite data set into a training subset and a validation subset, and then, at 316, trains a model (e.g., a Residual Network or Residual Neural Network (RESNET) model (e.g., RESNET 1D, etc.) in the illustrated method 300, etc.) with the training data. In this example, the RESNET model network includes an architecture illustrated in FIG. 3, where a number n of residual blocks is included, along with a final SoftMax classifier. In this example embodiment, the number n is three to indicate three residual blocks. In addition, the architecture includes fully connected layers (FC) and a GAP layer (not shown) following the residual blocks. Also, the final SoftMax classifier includes a number of neurons equal to the number of classes in a dataset. Further, the example RESENT model includes a shortcut residual connection between consecutive convolutional layers, and a linear shortcut is added to link the output of a residual block to its input thus enabling the flow of the gradient directly through these connections. In this manner, the training is simplified by reducing the vanishing gradient effect.

That said, it should be understood that the model may include, for example, a XGBoost model or a random forest, in one or more embodiments, or may be otherwise in still other embodiments. The trained model is then validated (and/or evaluated) through the validation subset of the composite data set.

After the model is trained, the computing device 102 requests particular field data, at 318, by identifying a specific field (e.g., field 106, etc.) for which tillage is to be evaluated (e.g., automatically, in response to an input from a grower or user, etc.). In connection therewith, the computing device 102 accesses images for the field for an interval prior to planting of the field (e.g., about three months prior to planting the field, about two months prior to planting the field, about one month prior to planting the field, etc.), and then for another interval after planting of the field (e.g., about one month after planting the field, about two months after planting the field, about three months after planting the field, about four months after planting the field, about five months after planting the field, about six months after planting the field, etc.). The computing device 102 then repeats steps 302 and 306-312 for the data associated with the particular field, whereby a composite data set is compiled (with spectral indices). The composite data set includes the images of the field, as limited by the field boundary geometry, and indices of the band data from the images. In doing so, for example, for each field, median values may be computed at a pixel-level from the images (e.g., after QC masking has been done, etc.) for each interval of a larger given interval.

The computing device 102 then applies the trained model, at 320, whereby each pixel of the accessed/received field images is assigned a tillage intensity selected from, for example, conventional tilling (CT), moderate tilling (MT), or no tilling (NT) in this example. Along with the tillage intensity, the model also provides probabilities of the tillage intensities. For instance, the pixels have all the probabilities to belong to certain tillage types (CT/MT/NT), which comes from the model classifier. The computing device 102, via the model, aggregates a field-level result for each field by summarizing the probabilities for all the classes and then determines a likely class for the whole field (e.g., at the pixel level, under an inference mode; etc.). In some embodiments, the computing device 102 may assign an actual tillage percentage to each pixel of the images.

The computing device 102 then aggregates the tillage intensities into a map, at 322, whereby a tillage map for the field (e.g., for field 106, etc.) is compiled. FIG. 5 illustrates an example aggregate tillage map 500, in which each segment of a field is associated with a color, pattern or other visual distinction of the intensity of tillage for that location. As shown, the map includes different visual distinction for each of conventional tilling (CT), no tilling (NT), moderate tilling (MT) (or reduced tillage), and strip-till. Strip-till, in generally, is a conservation system that uses a minimum tillage. It combines the soil drying and warming benefits of conventional tillage with the soil-protecting advantages of no-till by disturbing only the portion of the soil that is to contain the seed row. While illustrate separately in the example map of FIG. 5, in various embodiments herein strip-till is merged with (or classified with) moderate tilling. As described, the map may then be used and/or leveraged to inform one or more crop management decisions with regard to the field 106 (e.g., application of desired treatments to the fields such as pesticides, a herbicides, and/or a fertilizers; etc.).

In view of the above, the systems and methods herein provide for mapping of tillage intensities in regions (e.g., in fields in the regions, etc.), based on images of the regions, through a trained classifier model. In this manner, an objective (and generally automated) designation of tillage in the regions, based on image data (and specifically, for example, NIR band values, which are associated with cellulose and lignin absorption features (e.g., between 2100 nm and 2300 nm,), etc.), etc.), is provided, which avoids manual intervention and data compilation by individual growers, etc. (e.g., whereby the objective designation of tillage may be relied upon for completeness and accuracy, etc.), etc. In turn, from the mapping, one or more crop management decisions may be implemented with regard to the regions and, more particularly, the fields in the regions (e.g., application of desired treatments to the fields such as pesticides, a herbicides, and/or a fertilizers; etc.).

The systems and methods herein may leverage data preprocessing to account for coverage, frequency and quality of the image data, while capturing spatial-temporal patterns of residue to inform the tillage classes of the field.

Further, the tillage characteristics achieved via the systems and methods herein may be employed in a variety of different implementations. For example, in one implementation, the tillage characteristics may be indicative of field conditions and utilized in selecting crops for planting, crops for harvest, treatment options for crops/fields, etc.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects, features, operations, etc. of the present disclosure may transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing an image of one or more fields, the image including multiple pixels, each of the pixels including a value for each of multiple bands; (b) deriving at least one index value for each of the pixels of the image; (c) generating a map of tillage for the one or more fields using a trained model and the at least one index value for each of the pixels of the image; (d) storing the map of tillage for the one or more fields in a memory; and/or (e) causing display of the map of tillage for the one or more fields at an output device.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in processing image data associated with fields, the method comprising:
accessing, by a computing device, an image of one or more fields, the image including multiple pixels, each of the pixels including a value for each of multiple bands;
deriving, by the computing device, at least one index value for the image;
generating a map of tillage for the one or more fields, using a trained model and the at least one index value for each of the pixels of the image, the map of tillage indicating a location and an intensity of the tillage for one or more segments of the one of more fields;
storing, by the computing device, the map of tillage for the one or more fields in a memory; and
causing display of the map of tillage for the one or more fields at an output device.

2. The computer-implemented method of claim 1, wherein the multiple bands include red, blue, green and near infrared.

3. The computer-implemented method of claim 1, wherein deriving the at least one index value for the image includes deriving at least one index value for each of the pixels of the image.

4. The computer-implemented method of claim 3, wherein deriving the at least one index value for each of the pixels of the image includes deriving the at least on index value for each of the pixels of the image based on the following:
NDVI=(nir−red)/(nir+red);
wherein nir is a near infrared band value and red is a red band value.

5. The computer-implemented method of claim 1, wherein generating the map of tillage for the one or more fields includes identifying, on the map, at least one intensity of the tillage for the one or more fields.

6. The computer-implemented method of claim 1, wherein the model includes a Residual Network (RESNET) model.

7. The computer-implemented method of claim 6, further comprising:
accessing images of multiple fields;
accessing tillage data associated with the multiple fields;
aggregating the images of the multiple fields and the tillage data associated with the multiple fields into a composite data set; and
prior to generating a map of tillage for the one or more fields using the trained model, training the RESNET model to identify tillage in the multiple fields.

8. The computer-implemented method of claim 1, wherein the model includes a XGBoost model.

9. The computer-implemented method of claim 1, further comprising treating the one or more fields based on the map of tillage for the one or more fields.

10. The computer-implemented method of claim 9, wherein treating the one or more fields includes applying one or more of a pesticide, a herbicide, and/or a fertilizer to the one or more fields.

11. A non-transitory computer-readable storage medium including executable instructions for processing image data associated with fields, which when executed by at least one processor, cause the at least one processor to perform one or more of the steps in the claims above.
access an image of one or more fields, the image including multiple pixels, each of the pixels including a value for each of multiple bands;
derive at least one index value for the image;
generate a map for the one or more fields, using a trained model and the at least one index value for each of the pixels of the image, the map indicating a location and an intensity of at least one characteristic for one or more segments of the one of more fields;
store the map for the one or more fields in a memory; and
cause display of the map for the one or more fields at an output device.

12. A system for use in processing image data associated with fields, the system comprising a computing device configured to:
access an image of one or more fields, the image including multiple pixels, each of the pixels including a value for each of multiple bands;
derive at least one index value for the image;
generate a map of tillage for the one or more fields using a trained model and the at least one index value for each of the pixels of the image, the map of tillage indicating a location and an intensity of the tillage for one or more segments of the one of more fields;
store the map of tillage for the one or more fields in a memory; and
cause display of the map of tillage for the one or more fields at an output device.

13. The system of claim 12, wherein the multiple bands include red, blue, green and near infrared.

14. The system of any 13, wherein the computing device is configured, in order to derive the at least one index value for the image, to derive at least one index value for each of the pixels of the image.

15. The system of claim 14, wherein the computing device is configured, in order to derive the at least one index value for the image, to derive the at least on index value for each of the pixels of the image based on the following:
NDVI=(nir−red)/(nir+red);
wherein nir is a near infrared band value and red is a red band value.

16. The system of claim 12, wherein the model includes a Residual Network (RESNET) model.

17. The system of claim 16, wherein the computing device is further configured to:
access images of multiple fields;
access tillage data associated with the multiple fields;
aggrege the images of the multiple fields and the tillage data associated with the multiple fields into a composite data set; and
prior to generating a map of tillage for the one or more fields using the trained model, train the RESNET model to identify tillage in the multiple fields.

18. The system of claim 12, wherein the computing device is further configured to direct operation of a farm implement at the one or more fields to treat the one or more fields with a treatment based on the map of tillage for the one or more fields.

19. The system of claim 18, wherein the treatment includes one or more of a pesticide, a herbicide, and/or a fertilizer.
